(19) United States
(12) Patent Application Publication
(10) Pub. No.: US 2026/0171708 A1
(43) Pub. Date: Jun. 18, 2026

(54) LASER WELDED STRAIN RELIEF

(71) Applicant: Aptiv Technologies AG, Schaffhausen (CH)

(72) Inventors: Jeffrey S. CAMPBELL, West Bloomfield, MI (US); Wesley Ward Weber, JR., Lapeer, MI (US)

(21) Appl. No.: 18/982,624

(22) Filed: Dec. 16, 2024

(51) Int. Cl. H01R 13/436; H01R 13/66; H01R 43/02

(52) U.S. Cl. CPC H01R 13/4365; H01R 13/6658; H01R 43/0228

(57) ABSTRACT

An end cap is described that includes a first end configured to be seated on a connector and a second end configured to receive an insulative covering of a flexible circuit. The end cap includes at least one window configured to enable access to laser weld the insulative covering to the end cap when the end cap is seated in a staged position on a connector. A method is also described that includes laser welding a terminal through at least one window of a connector, moving an end cap from a pre-staged position to a fully seated position on the connector, and laser welding the insulative covering to the end cap through at least one window of the end cap.

### TECHNICAL FIELD OF THE INVENTION

This disclosure relates to wiring harnesses and cabling and more specifically, devices and techniques to enable effective coupling to flexible circuits.

### BACKGROUND

Wiring harnesses are commonly used to couple electrical components to one another, for example within a vehicle assembly. Traditional wiring harnesses utilized rounded cabling for many applications. Flexible circuits, which include a plurality of elongate electrical conductors and an insulative covering with a substantially flat outer surface, may offer an alternative to rounded cabling for use in wiring harnesses. A need exists for improvements in wiring harnesses that implement flexible circuits, including connections systems used to couple flexible circuits to other components.

### BRIEF DESCRIPTION OF THE DRAWINGS

FIG. 1 is an exploded view showing one example of a connection system according to some embodiments.

FIGS. 2A and 2B are straight on and angled perspective views, respectively, of a connector 110 according to some embodiments.

FIGS. 3A-3C are various perspective views of an end cap according to some embodiments.

FIGS. 4A-4C show various views of an end cap in a pre-staged position in some embodiments.

FIGS. 5A-5D show various views of an end cap in a staged position in some embodiments.

FIGS. 6A-6E are angled perspective views that show assembly of connection system according to some embodiments.

FIG. 7 is a flow diagram that depicts one example of a method of assembling a connection system according to some embodiments.

### SUMMARY

In some aspects, an end cap is described that includes a first end configured to be seated on a connector a second end configured to receive an insulative covering of a flexible circuit. The end cap includes at least one window configured to enable access to laser weld the insulative covering to the end cap when the end cap is seated in a staged position on the connector.

In some aspects, a method is described. The method includes laser welding a terminal of a connector to at least one elongate conductor of a flexible circuit that includes an insulative covering through at least one window of the connector. The method further includes moving an end cap from a pre-staged position on the connector to a fully staged position on the connector. The method further includes laser welding the insulative covering to the end cap through at least one window of the end cap.

### DETAILED DESCRIPTION

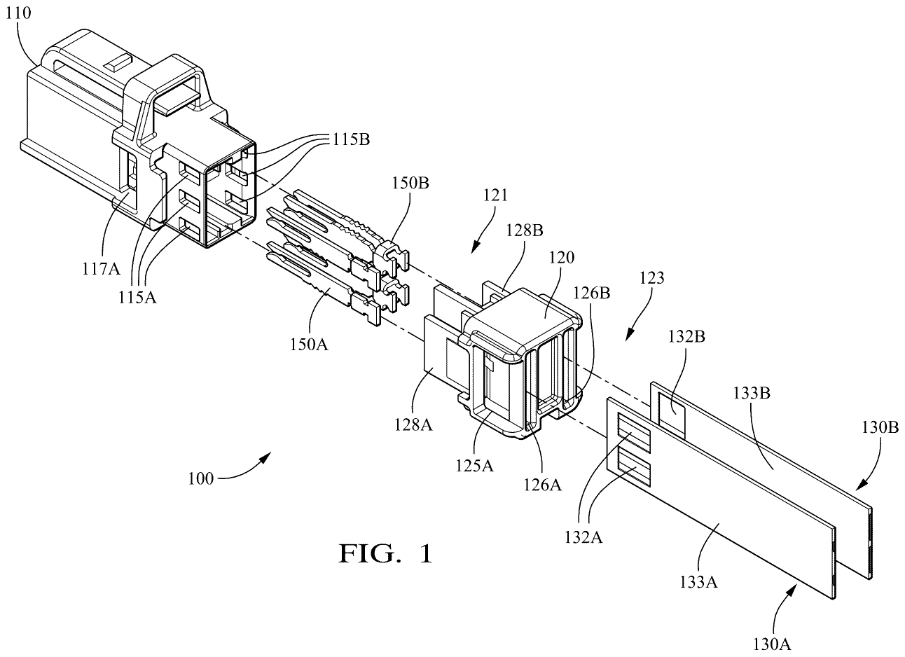

FIG. 1 is an exploded view showing one example of a connection system 100 according to some embodiments. The connection system 100 is uniquely configured to support laser welding of a relatively thin, flat structure like flexible circuits 130A, 130B depicted in FIG. 1, to provide strain relief for connection system 100.

As shown in FIG. 1, the connection system 100 includes a connector 110 and an end cap 120 with a first end 121 configured to be seated on the connector 110. The end cap 120 also includes a second end 123 configured to receive the flexible circuits 130A, 130B through pair of slots 126A, 126B for coupling.

As shown in the example of FIG. 1, the flexible circuit 130A, 130B includes a plurality of elongate conductors 132A, 132B that are encased in an insulative covering 133A, 133B. In some examples, the insulative covering 133A, 133B has a substantially planar surface and collectively protects and/or insulates a plurality of elongate conductors which are electrically isolated from one another by the insulative material of the insulative covering 133A, 133B. In some examples, the plurality of elongate conductors have a substantially flat planar surface, for example the plurality of elongate conductors may have a substantially rectangular or square shaped cross section.

As shown in the exploded view of FIG. 1, the connector 110 is configured to house a plurality of terminals, including a first terminal 150A comprising a pair of single terminals, and a second terminal 150B comprising two pair of interconnected terminals. The respective terminals 150A, 150B, which each include forks for electrical coupling to a corresponding terminal (not shown), are shown for illustrative purposes and are intended to be non-limiting. Connector 110 may include different types of terminals, and any number of terminals and/or interconnected pairs of terminals than shown in the FIG. 1 example. In the example of FIG. 1, connector 110 may include internal slots, channels, locks, or other structures configured to support and retain the terminals 150A, 150B.

In the example of FIG. 1, end cap 120 is configured to be seated on the connector 110 to enable access to the flexible circuit 130A, 130B to laser weld the flexible circuit 130A, 130B to the end cap 120 to provide strain relief for connection system 100, i.e., to prevent connection system 100 from unintended disconnection such that one or more of flexible circuits 130A, 130B become separated from the connector 110 and/or the end cap 120.

As shown in the FIG. 1 example, the end cap 120 includes a pair of windows 125A, 125B configured to enable access to the flexible circuits 130A, 130B, specifically the insulative covering 133A, 133B of the flexible circuits 130A, 130B, to laser weld the insulative covering 133A, 133B to the end cap 120 when the end cap 120 is in a staged position on the connector 110. Accordingly, end cap 120 and connector 110 are configured such that when flexible circuits 130A, 130B are inserted through slots 126A, 126B and pushed forward into the connector 110 with the end cap 120 seated on the connector 110, the end cap 120 secures the flexible circuits 130A, 130B in a defined position for welding. In the staged position, windows 125A, 125B of the end cap 120 are aligned with one or more window(s) 115A, 115B of the connector 110 such that the insulative covering 133A, 133B of the flexible circuit(s) 130A, 130B are exposed so that the flexible circuit 130A, 130B may be welded through the windows 125A, 125B and 115A-115C to the end cap 120 for purposes of strain relief.

In addition, connection system 100 may be uniquely configured to support laser welding of the flexible circuit 130A, 130B, specifically conductors 132A, 132B of the flexible circuit 130A, 130B, to terminals 150A, 150B housed in the connector 110. For example, the connector 110 may include a pair of windows 117A, 117B configured to be aligned with openings 137A, 137B in the insulative covering 133A, 133B when flexible circuit(s) 130A, 130B are seated in the connector 110, as well as terminals 150A, 150B housed within the connector 110, such that the elongate conductors 132A, 132B can be laser welded to the terminals 150A, 150B through the windows 117A, 117B of the connector 110.

In some examples, the end cap 120 does not cover the windows 117A, 117B and/or the openings 137A, 137B in the pre-staged position. In some examples, the end cap 120 includes tabs 128A, 128B at the first end 121 that cover the openings 137A, 137B in the staged position of the end cap 120, thereby protecting one or more weld(s) between the flexible circuit 130A, 130B and the terminals 150A, 150B.

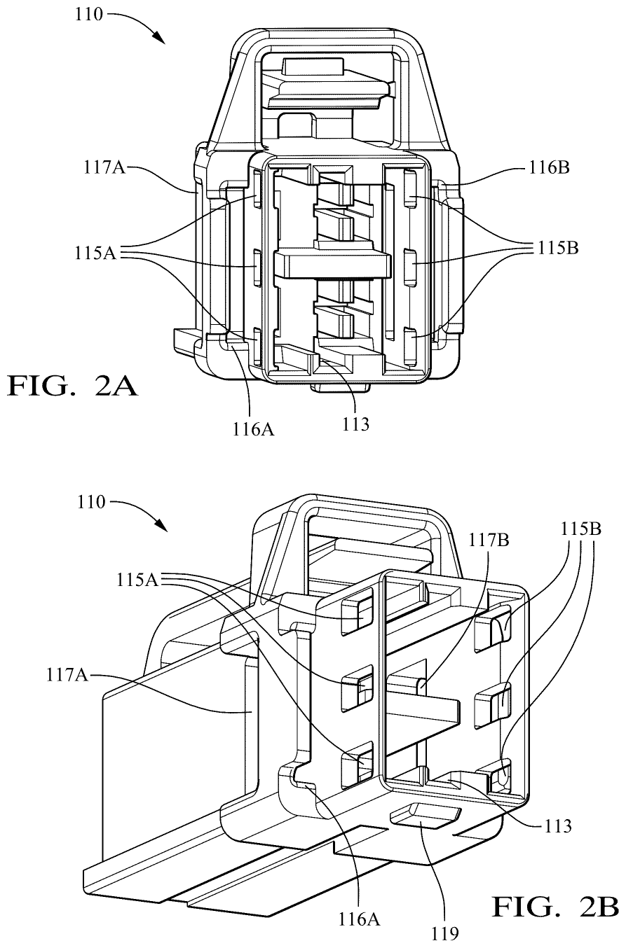

FIGS. 2A and 2B are straight on and angled perspective views, respectively, of a connector 110 according to some embodiments. In the example of FIGS. 2A and 2B connector 110 is configured to support a plurality of terminals, such as terminals 150A, 150B shown in FIG. 1 or other terminals, for coupling.

As shown in FIGS. 2A and 2B, the connector 110 includes a pair of channels 116A, 116B, which correspond to slots 126A, 126B in end cap 120, and are configured to receive flexible circuits 130A, 130B in the channels 116A, 116B. In some examples, the channels 116A, 116B may have a length that defines a coupling position of the flexible circuits 130A, 130B in the channels 116A, 116B, i.e., when the flexible circuits 130A, 130B are moved forward into the channels 116A, 116B so that an end of the flexible circuits 130A, 130B reach a back of the channels 116A, 116B.

As shown in FIG. 2B, the connector 110 includes windows 117A, 117B in each side of connector 110. Each of windows 117A, 117B is positioned to correspond to openings 137A, 137B in the insulative covering 133A, 133B of the flexible circuits 130A, 130B that expose the elongate conductors 132A, 132B when the flexible circuits 130A, 130B are arranged in the connector 110. Windows 117A, 117B may enable access to laser weld terminals housed in the connector 110 to the elongate conductors 132A, 132B through the openings 137A, 137B exposed by the windows 117A, 117B.

As shown in FIG. 2A, and 2B, connector 110 further includes a further plurality of windows 115A, 115B at respective sides of the connector 110. The windows 115A, 115B are configured to be aligned with corresponding windows 125A, 125B of the end cap 120 in a staged position of the end cap 120 (e.g., where the end cap is fully seated on the connector 110 with flexible circuits 130A, 130B staged in channels 116A, 116B) to enable laser welding of the flexible circuits 130A, 130B to the end cap 120. For example, the windows 115A, 115B may each correspond to positions along the flexible circuits 130A, 130B between the elongate conductors 132A, 132B and/or other positions along a planar surface of the flexible circuits 130A, 130B that do not include a conductor or other material that might block a laser from passing through the insulative covering 133A, 133B to weld the insulative covering 133A, 133B to the end cap 120.

As also shown in FIG. 2B, connector 110 includes a protrusion 119 on an exterior surface. In some examples, the end cap 120 is configured to seated on the connector 110 in front of the protrusion 119 in the pre-staged position, and moved past the protrusion to when moved from the pre-staged position to the staged position on the connector 110, in which the flexible circuits 130A, 130B are secured in the channels 116A, 116B in position to be welded. As also shown in FIG. 2B, connector 110 includes a guide channel 113, which may be configured to engage with a corresponding retaining feature 127 of the end cap 120 to retain the end cap 120 seated on the connector 110 during the assembly process.

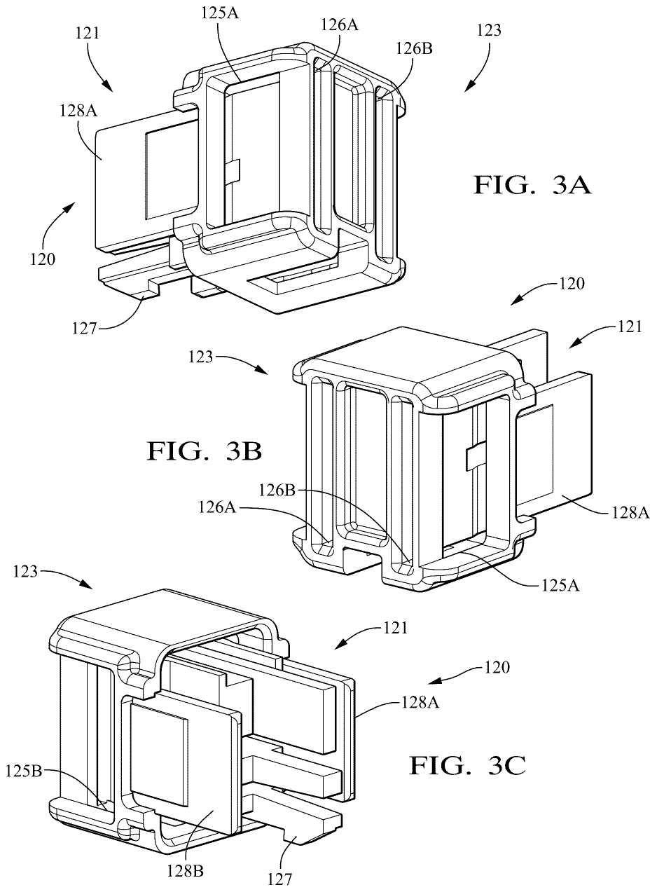

FIGS. 3A-3C are various perspective views of an end cap 120 according to some embodiments. As shown in FIGS. 3A-3C, the end cap 120 includes a first end 121 and a second end 123 opposed to the first end 121. The first end 121 is configured to be seated on a connector 110 as shown in FIGS. 2A and 2B. The second end 123 is configured to receive a flexible circuit 130A, 130B through slots 126A, 126B that correspond to channels 116A, 116B in the connector 110 as shown in FIGS. 2A and 2B. The second end 123 includes a retaining feature 127 configured to engage with a guide channel 113 in the connector 110 as shown in FIGS. 2A-2B to retain the end cap 120 seated on the connector 110 during the assembly process, for example when the end cap 120 is moved from a pre-staged position to a staged position seated on the connector 110.

As shown in FIGS. 3A-3C, the end cap 120 includes windows 125A, 125B. Windows 125A, 125B are configured to be aligned with corresponding windows 115A, 115B of connector 110 in a staged position of the end cap fully seated on the connector 110 to enable access to laser weld the insulative covering 133A, 133B to the end cap 120 through the windows 125A, 125B.

As also shown in FIGS. 3A-3C, the first end 121 of the end cap 120 includes tabs 128A, 128B. In a staged position of the end cap 120, the tabs 128A, 128B may cover the openings 137A, 137B in the insulative covering 133A, 133B and thereby protect and insulate welds between the elongate conductors 132A, 132B and the terminals.

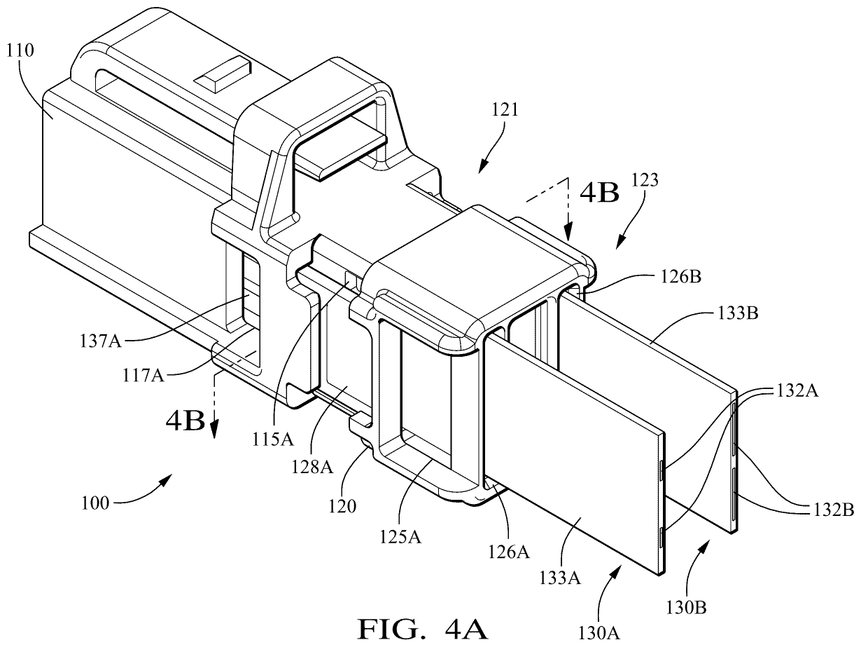

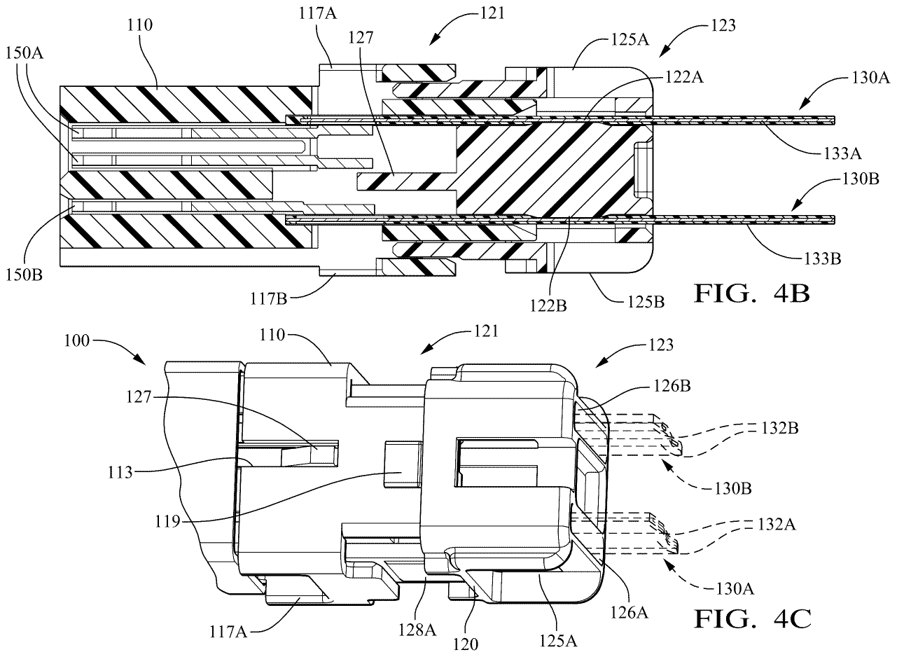

FIG. 4A shows an angled perspective view of a top side of connection system 100 with the end cap 120 in a pre-staged position in some embodiments. FIG. 4B depicts a cross-sectional view of connection system 100 along the cut lines shown in FIG. 4A. FIG. 4C shows an angled perspective view of a bottom side of connection system 100 with the end cap 120 in a pre-staged position in some embodiments.

As shown in FIGS. 4A-4C, in the pre-staged position, the flexible circuits 130A, 130B extend through slots 126A, 126B in the end cap 120 seated in the channels 116A, 116B of connector 110. In the pre-staged position, windows 117A, 117B of the connector 110 are aligned with openings 137A, 137B in the insulative covering 133A, 133B that expose elongate conductors 132A, 132B, such that laser light incident on a surface of the elongate conductors 132A, 132B exposed through the openings 137A, 137B may weld an opposed surface of the elongate conductors 132A, 132B to a terminal 150A, 150B in the connector 110. In the pre-staged position shown in FIGS. 4A-4C, the flexible circuits 130A, 130B are supported in the channels 116A, 116B through the slots 126A, 126B.

Referring to FIG. 4A, in the pre-staged position shown in FIG. 4A, the end cap 120 is enables access to laser weld the elongate conductors 132A, 132B to the terminals 150A, 150B. For example, as shown in FIG. 4A, tabs 128A, 128B at the first end 121 are positioned such that they do not cover windows 117A, 117B and/or openings 137A, 137B or otherwise impede laser welding of the elongate conductors 32A, 132B to the terminals 150A, 150B.

Referring to FIG. 4B, end cap 120 includes ramp features 122A, 122B that engage with the flexible circuits 130A, 130B within the channels 116A, 116B. As shown in FIG. 4B, the ramp features 122A, 122B within the channels 116A, 116B do not impede movement of the flexible circuits 130A, 130B in the pre-staged position of the end cap 120.

Referring to FIG. 4C, the retaining feature 127 of the end cap 120 is engaged with a corresponding guidance track 113 in the connector when the end cap 120 is seated on the connector 110. As shown in FIG. 4C, the end cap 120 is positioned before a protrusion 119 on the connector 110.

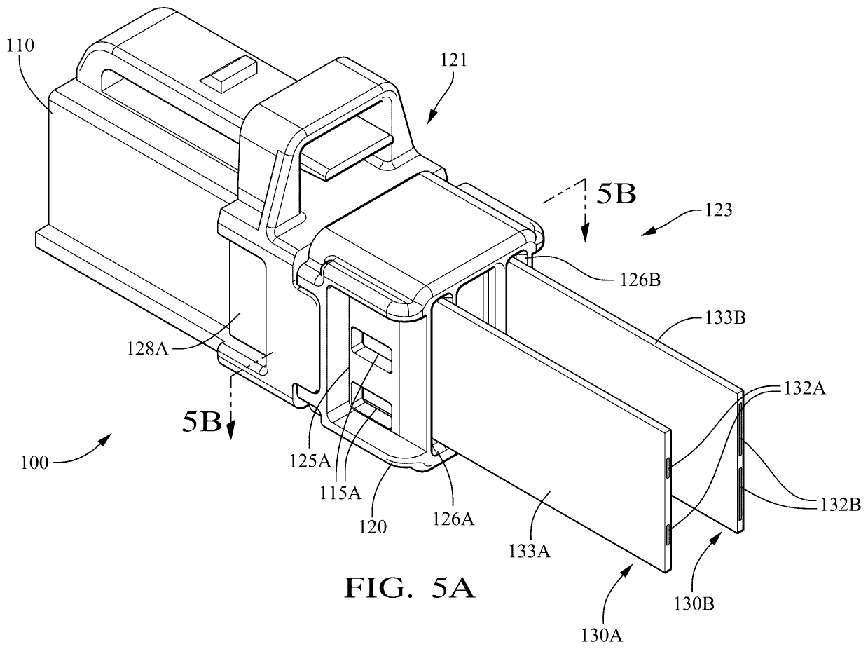

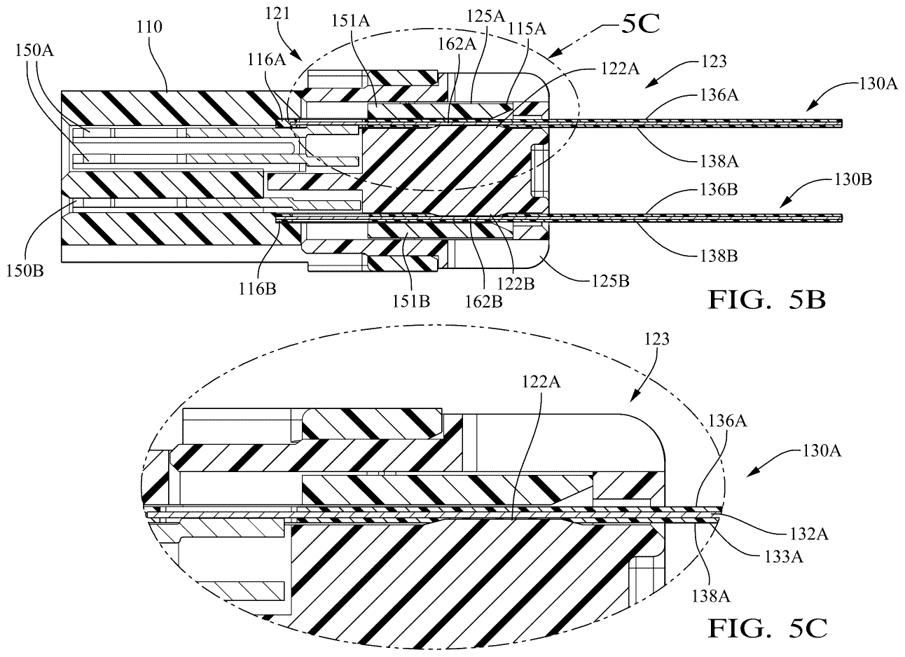

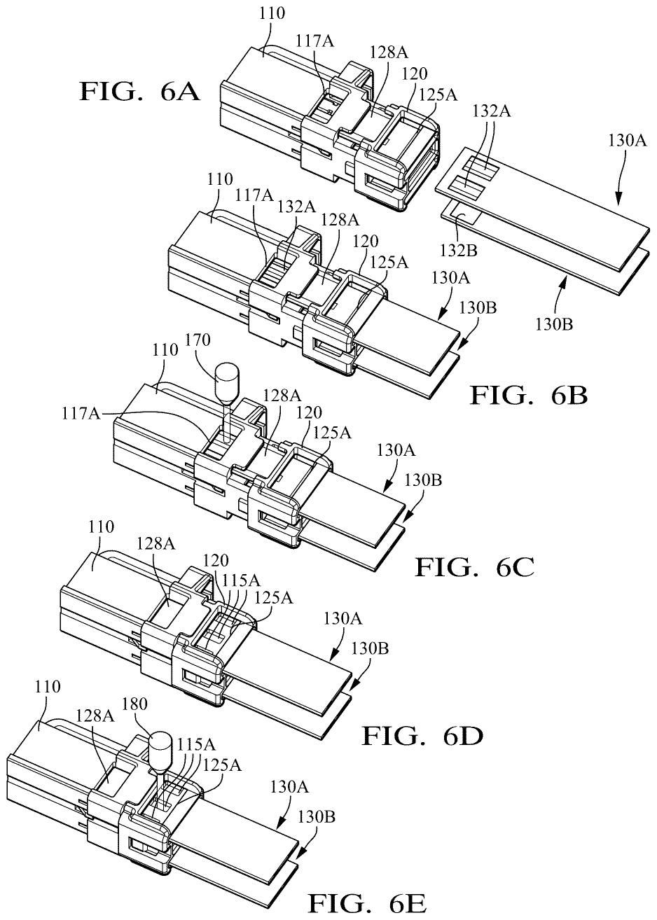

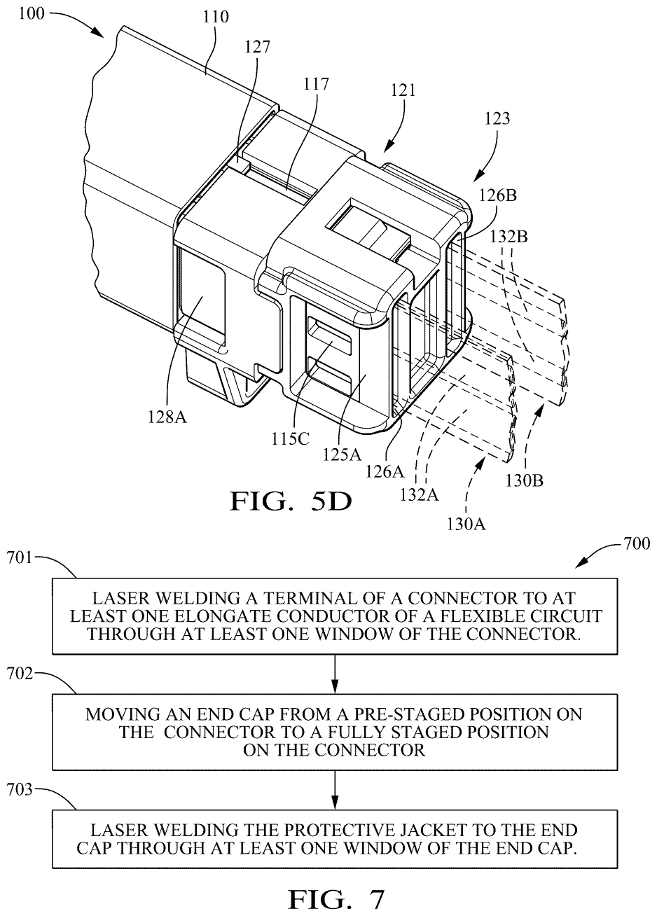

FIG. 5A shows an angled perspective view of a top side of connection system 100 with the end cap 120 after it has been moved to a staged position in some embodiments. FIG. 5B depicts a cross-sectional view of connection system 100 along the cut lines shown in FIG. 5A. FIG. 5C shows the cross-sectional view of FIG. 5B zoomed in on ramp feature 122A. FIG. 5D shows an angled perspective view of a bottom side of the connection system 100 with the end cap 120 in a staged position in some embodiments.

In the example of FIGS. 5A-5D, connection system 100 is shown after the end cap 120 has been moved to a staged position on the connector 110, which secures flexible circuits 130A, 130B seated in channels 116A, 116B of connector 110, extending through slots 126A, 126B of the end cap 120. As shown in FIG. 5A, in the staged position, a position of windows 125A, 125B corresponds to a position of windows 115A, 115B of the connector 110, such that the flexible circuit 130A, 130B may be laser welded to the end cap 120 through the respective windows 115A, 115B, 125A, 125B. In some examples, the windows 115A, 115B are positioned to correspond to portions of the flexible circuit 130A, 130B that do not include an elongate conductor or other material that might block a laser from welding the insulative covering 133A to the end cap 120, e.g., in regions between or alongside elongate conductors of the flexible circuit 130A, 130B that are primarily filled with a non-conductive material.

Referring back to FIG. 4A, in some examples, the elongate conductors 132A, 132B of the flexible circuit 130A, 130B may be laser welded to terminals 150A, 150B housed in the connector 110 through openings 137A, in the insulative covering 133A, 133B. As shown in FIG. 5A, in the staged position of the end cap 120, tabs 128A, 128B at the first end 121 of the end cap 120 are positioned to cover the openings 137A and protect previously formed welds between the elongate conductors 132A, 132B and the terminals 150A, 150B. In this manner, moving the end cap 120 to the staged position shown in FIG. 5A enables laser welding of the flexible circuit 130A, 130B to the end cap 120 to provide stain relief, and positions the end cap 120 to serve as a protective cover of welds between elongate conductors 132A, 132B and the terminals 150A, 150B.

As previously mentioned, moving the end cap 120 to the staged position shown in FIG. 5A causes the flexible circuit 130A, 130B to be secured in the connector 110, meaning that flexible circuit 130A, 130B may not be freely moved in and out of the second end 123 of the end cap 120. As shown in FIGS. 5B and 5C, the end cap 120 includes ramp features 122A, 122B with a contact surfaces 162A, 162B arranged to contact the flexible circuits 130A, 130B in the channels 116A, 116B. In some examples, moving the end cap 120 to the staged position shown in FIG. 5B causes the ramp features 122A, 122B to compress the flexible circuits 130A, 130B between the ramp feature 122A, 122B and a wall 151A, 151B of the channels 116A, 116B to secure the flexible circuits 130A, 130B in the channels 116A, 116B. In some examples, the contact surfaces 162A, 162B are positioned to correspond to a position of windows 125A, 125B and/or 116A, 116C such that the insulative covering 133A, 133B may be laser welded to the end cap 120 at the contact surfaces 162A, 162B. In this manner, the ramp features 122A, 122B secure a position of the flexible circuits 130A, 130B and to serve as a defined surface to weld the insulative covering 133A, 133B to the end cap 120.

Referring now to FIGS. 5B and 5C, the insulative covering 133A, 133B of the respective flexible circuits 130A, 130B may include a first planar surface 136A, 136B and a second planar surface 138A, 138B opposed to the first planar surface 136A, 136B. In some examples, connection system 100 may be configured to enable the insulative covering 133A, 133B to be laser welded to the end cap 120 (e.g., the contact surfaces 162A, 162B through windows 125A, 125B/115A, 115B) such that light incident on the first planar surface 136A, 136B travels through the insulative covering of the flexible circuit 130A, 130B to weld the second planar surface 138A, 138B of the flexible circuit to the end cap 120.

In some examples, the insulative covering 133A, 133B of the flexible circuits 130A, 130B may be formed of a relatively thin materials configured to allow laser light to pass from a first planar surface 136A, 136B to weld the second planar surface 138A, 138B to the end cap 120. As one non-limiting example, the insulative covering may be formed of one or more of a Polyethylene terephthalate (PET) material and a Thermoplastic polyurethane (TPU) material. In some examples, at least part of the end cap 120, such as contact surfaces 162A, 162B, include one or more of a Polybutylene terephthalate (PBT) and a Polyamide 66(PA 66 ) material.

Referring now to FIG. 5D, in the staged position, the end cap 120 has been moved past the protrusion 119 in the connector 110, which secures end cap 120 in the staged position with retaining feature 127 engaged with track 117. In some examples, moving the end cap 120 past the protrusion 119 causes the ramp features 122A, 122B of the end cap 120 to engage with flexible circuit 130A, 130B and secure the flexible circuit in position as shown in FIG. 5B.

FIGS. 6A-6E are angled perspective views that show assembly of connection system 100 according to some embodiments. As shown in FIG. 6A, in a first step, the end cap 120 is seated on the connector 110 in a pre-staged position as shown in FIGS. 4A-4C. As shown in FIG. 6B, flexible circuits 130A, 130B are inserted into slots 126A, 126B and moved forward into channels 116A, 116B. In the pre-staged position with the flexible circuits 130A, 130B aligned in the slots 116A, 116B, windows 117A, 117B of the connector 110 are aligned with openings 137A, 137B in the insulative covering 133A, 133B of the flexible circuits 130A, 130B, exposing elongate conductors 132A, 132B of the flexible circuits for laser welding to one or more terminal(s) 150A, 150B in the connector 110. As shown in FIG. 6C, in the pre-staged position as shown, a laser device 170 emits light of a wavelength that forms a laser weld between the elongate conductors 132A, 132B and the terminal(s) 150A, 150B.

As shown in FIG. 6D, after the laser welds are formed in FIG. 6C, the end cap 120 may be moved from the pre-staged position to the staged position on the connector 110. As shown in FIG. 6D, in the staged position windows 125A, 125B of the end cap 120 are aligned with windows 115A, 115B of the connector 110, tabs 128A, 128B cover the openings 137A, 137B, and the welds between the elongate conductors 132A, 132B and the terminal(s) 150A, 150B. As shown in FIG. 6E, a laser device 180, which may be the same or different than laser device 170 depicted in FIG. 6C and configured to emit laser light of the same or a different wavelength to weld the insulative covering 133A, 133B of the flexible circuits 130A, 130B to the end cap 120. In some examples, the laser device 170 illuminates regions of the flexible circuit 130A, 130B that are exposed through the windows 125A, 125B and the windows 115A, 115B, which may be aligned with regions between elongate conductors 132A, 132B of the flexible circuit 130A, 130B.

FIG. 7 is a flow diagram that depicts one example of a method of assembling a connection system 100 according to some embodiments. As shown in FIG. 7, at 701, the method includes laser welding a terminal 150A, 150B of a connector 110 to at least one elongate conductor 132A, 132B of a flexible circuit 130A, 130B that includes an insulative covering 133A, 133B through at least one window 117A, 117B of the connector 110. As also shown in FIG. 7, at 702, the method further includes moving an end cap 120 from a pre-staged position on the connector 110 as shown in FIGS. 4A-4C, to a staged position on the connector 110 as shown in FIGS. 5A, 5D. As shown in FIG. 7, at 703, the method further includes laser welding the insulative covering 133A, 133B to the end cap through at least one window 125A, 125B of the end cap 120.

In some examples, the at least one window of the connector 110 includes a first at least one window 117A, 117B, and the method further includes laser welding the insulative covering 133A, 133B of the flexible circuit 130A, 130B to the end cap 120 through a second at least one window 115A, 115B of the connector 110. In some examples, the second at least one window includes a plurality of second windows 115A, 115B with positions that correspond to locations between or otherwise alongside the first and second elongate conductors 132A, 132B. In some examples, a terminal 150A, 150B is laser welded to the at least one elongate conductor 132A, 132B through at least one opening 137A, 137B in the insulative covering 133A, 133B, and the method further includes covering the at least one opening 137A, 137B with the end cap 120 in the seated position to protect the at least one opening 137A, 137B.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. An end cap comprising:
a first end configured to be seated on a connector
a second end configured to receive an insulative covering of a flexible circuit;
at least one window configured to enable access to laser weld the insulative covering to the end cap when the end cap is seated in a staged position on the connector.

2. The end cap of claim 1, further comprising:
at least one ramp feature that exerts a force that pushes the flexible circuit against the connector when the end cap is fully seated on the connector.

3. The end cap of claim 2, wherein the at least one window is configured to enable access to laser weld the insulative covering to a surface of the at least one ramp feature.

4. The end cap of claim 1, wherein the end cap is configured to, in a pre-staged position seated on the connector, enable access to laser weld at least one terminal of the connector to at least one of a plurality of elongate conductors of the flexible circuit.

5. The end cap of claim 4, wherein the connector includes at least one window configured to enable access to laser weld the at least one terminal of the connector to at least one of the plurality of elongate conductors.

6. The end cap of claim 4, wherein the end cap is configured to be moved from the pre-staged position to the staged position in which the at least one window enables access to laser weld the insulative covering to the end cap after laser welding the at least one terminal of the connector to at least one of the plurality of elongate conductors.

7. The end cap of claim 6, wherein the end cap is configured to be moved past a protrusion in the connector when the end cap is moved from the pre-staged position to the staged position to secure the flexible circuit in the connector in position to laser weld the insulative covering to the end cap.

8. The end cap of claim 1, wherein the at least one window is configured to enable access to laser weld the insulative covering to the end cap to provide strain relief to prevent the flexible circuit from unintended disconnection from the connector.

9. The end cap of claim 1, further comprising:
at least one retaining feature configured to engage with a corresponding track in the connector to retain the end cap seated on the connector.

10. The end cap of claim 1, wherein the at least one window is configured to enable access such that laser light incident on a first substantially planar surface of the flexible circuit welds a second substantially planar surface of the flexible circuit to the end cap.

11. The end cap of claim 1, wherein the at least one window is configured to enable access such that a substantially flat exterior surface of the flexible circuit is welded to the end cap in positions between a plurality of elongate conductors of the flexible circuit.

12. The end cap of claim 11, wherein connector includes one or more windows positioned to correspond to the at least one window of the end cap to enable access to laser weld the insulative covering to the end cap when the end cap is fully seated on the connector.

13. The end cap of claim 12, wherein the one or more windows correspond to positions between the plurality of elongate conductors.

14. The end cap of claim 1, wherein the insulative covering is formed of one or more of a Polyethylene terephthalate (PET) material and a Thermoplastic polyurethane (TPU) material.

15. The end cap of claim 1, wherein at least part of the end cap includes one or more of a Polybutylene terephthalate (PBT) and a Polyamide 66 (PA 66) material.

16. The end cap of claim 1, wherein the end cap includes a tab configured to protect a weld between at least one terminal of the connector and the at least one of a plurality of elongate conductors of the flexible circuit when the end cap is seated on the connector.

17. A method comprising:
laser welding a terminal of a connector to at least one elongate conductor of a flexible circuit that includes an insulative covering through at least one window of the connector;
moving an end cap from a pre-staged position on the connector to a fully staged position on the connector; and
laser welding the insulative covering to the end cap through at least one window of the end cap.

18. The method of claim 17, wherein the at least one window of the connector comprises a first at least one window, and further comprising:
laser welding the insulative covering of the flexible circuit to the end cap through a second at least one window of the connector.

19. The method of claim 18, wherein the second at least one window comprises a plurality of second windows with positions that correspond to locations between first and second elongate conductors.

20. The method of claim 17, wherein the terminal is laser welded to the at least one elongate conductor through at least one opening in the insulative covering, and further comprising:
covering the at least one opening with the end cap in the staged position to protect the at least one opening.
